(19) United States
(12) Patent Application Publication
(10) Pub. No.: US 2015/0039228 A1
(43) Pub. Date: Feb. 5, 2015

(54) ULTRA-SHORT-TERM FORECASTING METHOD INCLUDING REAL-TIME MONITORING OF THE EFFECT OF UPPER AND LOWER COURSES

(71) Applicants: STATE GRID CORPORATION OF CHINA, Beijing (CN); GANSU ELETRIC POWER CORPORATION, Lan Zhou, Gansu Province (CN); GANSU ELETRIC POWER CORPORATION WIND POWER TECHNOLOGY CENTER, Lan Zhou, Gansu Province (CN)

(72) Inventors: Ningbo Wang, Lan Zhou (CN); Liang Lu, Lan Zhou (CN); Zhaorong Li, Lan Zhou (CN); Guangtu Liu, Lan Zhou (CN); Long Zhao, Lan Zhou (CN); Tiejun Zhang, Lan Zhou (CN); Dingmei Wang, Lan Zhou (CN); Ming Ma, Lan Zhou (CN); Yanhong Ma, Lan Zhou (CN); Xiaoxia Li, Lan Zhou (CN)

(21) Appl. No.: 14/378,358

(22) PCT Filed: Feb. 6, 2013
(86) PCT No.: PCT/CN2013/000123

§ 371 Date: Aug. 13, 2014

(30) Foreign Application Priority Data
Feb. 13, 2012 (CN) 201210031681.9

(51) Int. Cl. G01W 1/02

(52) U.S. Cl. CPC G01W 1/02
USPC 702/3

(57) ABSTRACT

An ultra-short-term forecasting method including real-time monitoring of the effect of upper and lower courses, comprising: obtaining ultra-short-term model forecast results through the model lattices based on the T639 global spectral model course library data source, the CALMET wind field diagnostic model and static data; establishing statistical equations on the effect of upper and lower courses between the corresponding reference index station and each target wind tower for obtaining the effect of upper and lower courses of the target wind towers based on the wind tower database of the target wind power base and combined with the wind direction and speed real-time monitoring data of the reference index stations in the upper and lower courses, forecasting the ultra-short-term wind speed changes of each target wind tower and correct combined with the ultra-short-term model forecast results to form forecasting of the ultra-short-term wind speed changes of the wind towers in the target wind power base; after repeated cycling, obtaining forecasting of the future ultra-short-term wind speed changes of the wind farms in the target wind power base at all altitudes in the target area. The forecasting method has high forecasting precision, good prediction accuracy and wide application range.

### TECHNICAL FIELD

The present invention relates to the field of meteorological wind energy forecasting technologies, and more particularly to an ultra-short-term forecasting method including real-time monitoring of the effect of upper and lower courses.

### BACKGROUND ART

Wind power is currently one of the promising green clean energies in the world. Accurate wind power forecasting has a very important role in reasonable allocation and utilization of wind power, power system stability, commercial operation and services for decision-making It generally uses statistical forecasting and dynamic forecasting. Wind power forecasting of wind farms may be obtained through wind power field forecast combined with the wind power generation of wind farms. In terms of time scale, wind power forecasting is divided into short-term forecasting (e.g., daily forecasting) and ultra-short-term forecasting (e.g., hourly forecasting).

In the early 1990s, some European countries had begun to develop wind power forecasting system and used it for forecasting service. Forecasting techniques mostly use medium-term weather forecast model nesting high-resolution limited-area model to forecast the wind power generation of wind farms, e.g., Danish Prediktor forecasting system that is currently used for short-term wind power forecasting business in Denmark, Spain, Ireland and Germany. Meanwhile, Wind Power Prediction Tool (WPPT) is also used for wind power forecasting business in some European areas.

After the mid-1990s, True Wind Solutions in the United States also began commercial wind power forecasting service. The wind power forecasting software eWind they developed is a forecasting system for wind farms and wind power generation consisting of high-resolution mesoscale meteorological numerical model and statistical model. eWind and Prediktor are currently used for forecasting service of two large wind farms in California.

In October 2002, the European Commission funded to launch the ANEMOS plan, aiming at developing advanced forecasting models better than the existing methods, emphasizing forecasting under complex terrain and extreme weather conditions while developing offshore wind power forecasting. The Canadian wind energy resource numerical evaluation and prediction software WEST is to make wind energy atlases with a resolution of 100-200 m by combing the mesoscale meteorological models MC2 and WASP for forecasting. In addition, systems currently used for wind power forecasting business include Previento (Germany), LocalPred and RegioPred (Spain) and HIRPOM (Ireland and Denmark), etc.

Therefore, improving mesoscale models based on weather forecast products that are the initial value through statistical downscaling methods is the mainstream method to improve the wind speed forecasting of wind farms. It is required to develop appropriate wind speed forecasting methods and processes and carry out short-term and imminent forecasting of wind speed at all altitudes necessary for wind farms using numerical prediction and statistics for some complex terrain (e.g., in Hexi area of Gansu) and underlying surfaces.

In the prior art, mesoscale models based on weather forecast products that are the initial value are generally improved through statistical downscaling methods to improve the wind speed forecasting of wind farms. How to improve forecasting precision in complex terrain and extreme weather conditions is still a technically difficult problem. There are not effective short-term and imminent wind speed forecasting methods for the complex terrain and underlying surfaces in Hexi area of Gansu. Moreover, the existing models have poor forecasting precision to sudden weathers and there is certain difficulty for 10-20 min wind speed forecasting of wind towers.

In the process of realization of the present invention, the inventors found that the prior art at least has defects such as low forecasting precision, poor prediction accuracy and narrow application range.

### SUMMARY OF THE INVENTION

The object of the present invention is to propose an ultra-short-term forecasting method including real-time monitoring of the effect of upper and lower courses in view of the above problems for high forecasting precision, good prediction accuracy and wide application range.

In order to achieve this object, the present invention employs the following technical solution: an ultra-short-term forecasting method including real-time monitoring of the effect of upper and lower courses, comprising the following steps:
a. obtaining ultra-short-term model forecast results through the model lattices by using the WRF-RUC (Weather Research and Forecasting-Rapid Update Cycle) system and the WRF3DVAR (Weather Research and Forecasting Three Dimensional Variational) variational assimilation technique based on the T639 global spectral model course library data source, the CALMET (California Meteorological Model) wind field diagnostic model and static data;
b. earring out numerical analysis and statistics and establishing statistical equations on the effect of upper and lower courses between the corresponding reference index station and each target wind tower for computing the effect of upper and lower courses of the target wind towers based on the wind tower database of the target wind power base and combined with the wind direction and speed real-time monitoring data of the reference index stations in the upper and lower courses;
c. forecasting the future ultra-short-term wind speed changes of each target wind tower based on the computed results on the effect of upper and lower courses of each target wind tower and making correction in combination with the ultra-short-term model forecast results to form forecasting of the ultra-short-term wind speed changes of the wind towers in the target wind power base;
d. obtaining forecast of the future ultra-short-term wind speed changes of the wind farms in the target wind power base at all altitudes in the target area after repeated cycling of the above operations.

Further, Step a specifically comprises the following substeps:
a1. Processing static data, downscaling the WRF mesoscale numerical forecasting model and generating model lattices based on the CALMET wind field diagnostic model;
a2. Reading the T639 global spectral model assimilated data, analyzing the meteorological field data in GRIB format in the T639 global spectral model assimilated data and interpolating into the corresponding model lattices based on the T639 global spectral model course library data source;
a3. Generating initial field and boundary conditions based on the meteorological field information on the model lattices; establishing main model program for cyclic integral forecast computation through analysis using the WRF-RUC system and the WRF3DVAR variational assimilation technique;
a4. Starting the main model program for cycle operation to achieve ultra-short-term forecasting and obtaining ultra-short-term model forecast results.

Further, Step a also comprises the following substep:
a5. Using plotting equipment to output model product, i.e., ultra-short-term model forecast results.

Further, in Step a2, the operation to interpolate the analytical results of the meteorological field data in GRIB (General Regularly-distributed Information in Binary form) format in the T639 global spectral model assimilated data into the corresponding model lattices specifically comprises the following steps:
a21. Interpolating the analytical results of the meteorological field data in GRIB format in the T639 global spectral model assimilated data into the corresponding model lattices horizontally;
a22. Interpolating the analytical results of the meteorological field data in GRIB format in the T639 global spectral model assimilated data into the corresponding model lattices vertically.

Further, before Step a21, it comprises the following substep: Preparing for lattice formulation or carry out model lattice formulation after obtaining the analytical results of the meteorological field data in GRIB format in the T639 global spectral model assimilated data.

Further, in Step a4, the cycle operation is running 8 cycles a day; in the 8 cycles, the cycles starting from 1200UTC are cold start and the others are hot start.

Further, Step b specifically comprises the following substeps:
b1. Obtaining the live monitoring data of the reference wind towers based on the wind tower database of the target wind power base;
b2. For each target wind tower, screening for reference index station with best correlation concerning the effect of upper and lower courses in different wind directions through the optimal subset method;
b3. Establishing statistical equations on the effect of upper and lower courses between the corresponding reference index station and each target wind tower through numerical analysis and statistics based on the live monitoring data of the reference wind towers;
b4. Computing the effect of upper and lower courses of the target wind towers through the statistical equations on the effect of upper and lower courses between the corresponding reference index station and each target wind tower based on the wind direction and speed real-time monitoring data of the reference index stations in the upper and lower courses;
b5. Forecasting the future ultra-short-term wind speed changes of each target wind tower based on the computed results on the effect of upper and lower courses of each target wind tower.

Further, in Step b4, the wind direction and speed real-time monitoring data of the reference index stations in the upper and lower courses include the effect of upper and lower courses and high and low altitude effect of wind speed.

Further, in Step b3, the statistical equations on the effect of upper and lower courses between the corresponding reference index station and each target wind tower include forecast equation on the wind speed of the wind power base in the future 0-3 hours; In step b5, the set time of the future ultra short term includes 5-10 minutes.

Preferably, in Step d, the target area includes areas in 10 m spacing within 10-120 m and the altitudes include 10 m altitude, 70 m altitude and 100 m altitude; in the forecasting of the future ultra-short-term wind speed changes of the wind farms in the target wind power base at all altitudes in the target area, the forecast efficiency is 60 hours and the forecast interval is 15 minutes.

The ultra-short-term forecasting method including real-time monitoring of the effect of upper and lower courses in the embodiments of the present invention, comprising: obtaining ultra-short-term model forecast results through the model lattices using the WRF-RUC system and the WRF3DVAR variational assimilation technique based on the T639 global spectral model course library data source, the CALMET wind field diagnostic model and static data; carrying out numerical analysis and statistics and establishing statistical equations on the effect of upper and lower courses between the corresponding reference index station and each target wind tower for computing the effect of upper and lower courses of the target wind towers based on the wind tower database of the target wind power base and combined with the wind direction and speed real-time monitoring data of the reference index stations in the upper and lower courses; forecasting the future ultra-short-term wind speed changes of each target wind tower based on the computed results on the effect of upper and lower courses of each target wind tower and making correction in combination with the ultra-short-term model forecast results to form forecasting of the ultra-short-term wind speed changes of the wind towers in the target wind power base; obtaining forecasting of the future ultra-short-term wind speed changes of the wind farms in the target wind power base at all altitudes in the target area after repeated cycling of the above operations. It may forecast the 10-20 min wind speed of the target wind towers and carry out short-term and imminent forecasting of wind speed at all altitudes required for wind farms. it overcame defects such as low forecasting precision, poor prediction accuracy and narrow application range in the prior art and achieve high forecasting precision, good prediction accuracy and wide application range.

Other features and advantages of the present invention will be set forth in the ensuing specification, and, in part from the description will become apparent, or by the embodiments of the present invention is to understand. The objects and other advantages of the present invention may be realized and obtained in the written specification, claims and drawings of the structure particularly pointed out in the drawings.

Below in conjunction with the accompanying drawings and embodiments, the technical solution of the present invention is described in further detail.

### BRIEF DESCRIPTION OF THE DRAWINGS

The drawings used to provide a further understanding of the present invention and constitute part of this specification are used to explain the present invention together with the embodiments of the present invention and do not constitute a limitation of the present invention.

In the accompanying drawings, in which:

FIG. 1 is a flow chart of the ultra-short-term forecasting method including real-time monitoring of the effect of upper and lower courses according to the present invention;

FIG. 2 is a flow chart for interpolating the T639 global spectral model assimilated data into the model lattices in the ultra-short-term forecasting method including real-time monitoring of the effect of upper and lower courses according to the present invention.

### DESCRIPTION OF THE PREFERRED EMBODIMENTS

Below in conjunction with the accompanying drawings, preferred embodiments of the present invention will be described. It should be understood that the preferred embodiments described herein are only used to illustrate and explain the present invention and are not intended to limit the present invention.

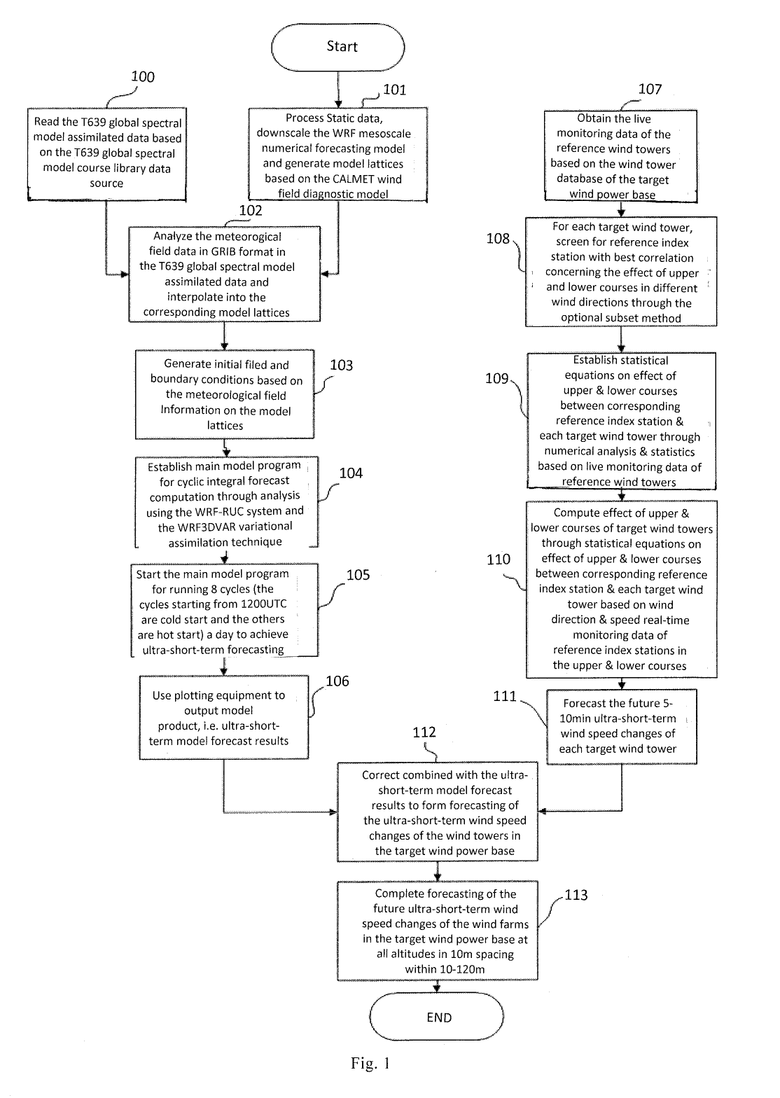

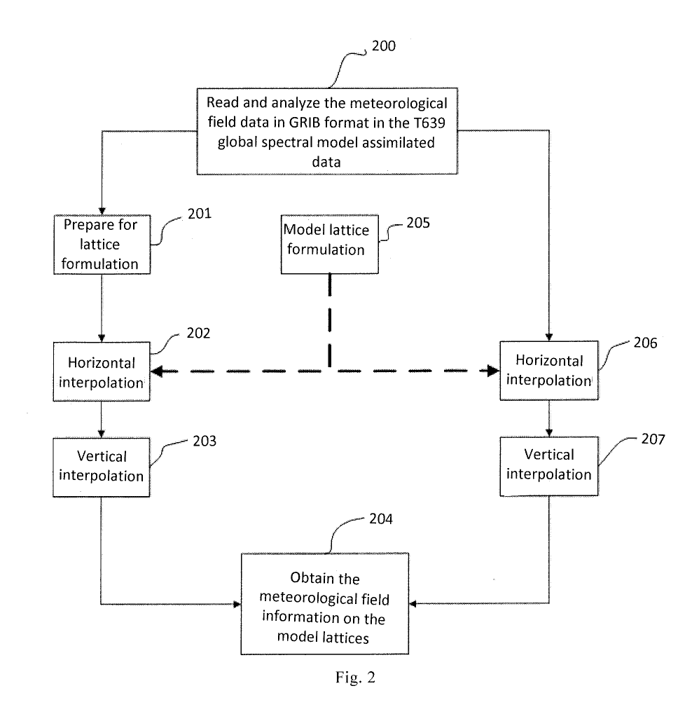

As shown in FIG. 1 and FIG. 2, provided in the embodiments of the present invention is an ultra-short-term forecasting method including real-time monitoring of the effect of upper and lower courses.

As shown in FIG. 1, the ultra-short-term forecasting method including real-time monitoring of the effect of upper and lower courses in the present embodiment, comprising the following steps:

Step 100: reading the T639 global spectral model assimilated data based on the T639 global spectral model course library data source;

In Step 100, the T639 model is the abbreviation for the TL639L60 global spectral model, which is upgraded and developed by the National Meteorological Center based on the T213L31 global spectral model. The T639 model predicts the rain range, location and mobile trend of general precipitation accurately and has a TS score of 56 for 24-hour light rain forecast; depicting such main influence systems as plateau trough, low-level southwest jet and southwest vortex and Eurasian large-scale middle-high latitude circulation background accurately; It has slightly poor model forecast performance for the vorticity field, divergence field and full wind speed of rainstorm power structure and good forecast effect for the specific humidity and water vapor flux divergence field of water vapor condition in a variety of physical quantity field test;

Step 101: processing static data, downscale the WRF mesoscale numerical forecasting model and generate model lattices based on the CALMET wind field diagnostic model;

Step 102: analyzing the meteorological field data in GRIB format in the T639 global spectral model assimilated data obtained via Step 100 and interpolating the analytical results into the corresponding model lattices obtained via Step 101;

Step 103: generating initial field and boundary conditions based on the meteorological field information on the model lattices obtained via Step 102;

Step 104: establishing main model program for cyclic integral forecast computation through analysis using the WRF-RUC system and the WRF3DVAR variational assimilation technique based on the initial field and boundary conditions obtained via Step 103;

Step 105: starting the main model program obtained via Step 104 for running multiple cycles a day to achieve ultra-short-term forecasting;

In Step 105, the main model program may be run 4 cycles a day, in which the cycles starting from 12UTC and 0OUTC are cold start and the others are hot start;

Step 106: using plotting equipment to output model product of the main model program, i.e., ultra-short-term model forecast results;

Step 107: obtaining the live monitoring data of the reference wind towers based on the wind tower database of the target wind power base;

Step 108: for each target wind tower, screening for reference index station with best correlation concerning the effect of upper and lower courses in different wind directions through the optimal subset method based on the live monitoring data of the reference wind towers obtained via Step 107;

Step 109: establishing statistical equations on the effect of upper and lower courses between the reference index stations obtained via Step 108 and each target wind tower through numerical analysis and statistics based on the live monitoring data of the reference wind towers;

In Step 109, the statistical equations on the effect of upper and lower courses between the reference index stations and each target wind tower include forecast equation on the wind speed of the wind power base in the future 0-3 hours;

Step 110: computing the effect of upper and lower courses of the target wind towers through the statistical equations on the effect of upper and lower courses between the corresponding reference index station and each target wind tower based on the wind direction and speed real-time monitoring data of the reference index stations in the upper and lower courses;

In Step 110, the wind direction and speed real-time monitoring data of the reference index stations in the upper and lower courses include the effect of upper and lower courses and high and low altitude effect of wind speed;

Step 111: forecasting the future (e.g., future 5-10 min) ultra-short-term wind speed changes of the target wind towers based on the computed results on the effect of upper and lower courses of the target wind towers obtained via Step 110;

Step 112: correcting the forecast results of the future 5-10 min ultra-short-term wind speed changes of the target wind towers obtained via Step 111 combined with the ultra-short-term model forecast results obtained via Step 106 to form forecasting of the ultra-short-term wind speed changes of the wind towers in the target wind power base;

Step 113: after repeated cycling of the above operations, completing forecasting of the future ultra-short-term wind speed changes of the wind farms in the target wind power base at all altitudes (including 10 m altitude, 70 m altitude and 100 m altitude) in 10 m spacing within 10-120 m (i.e., the target area);

In Step 113, in the forecasting of the future ultra-short-term wind speed changes of the wind farms in the target wind power base at all altitudes in the target area, the forecast efficiency is 48-hour and the forecast interval is 1 hour.

As shown in FIG. 2, in the above embodiment, the operation to interpolate the analytical results of the meteorological field data in GRIB format in the T639 global spectral model assimilated data into the corresponding model lattices specifically comprises the following steps:

Step 200: reading and analyzing the meteorological field data in GRIB format in the T639 global spectral model assimilated data and performing Step 201 or Step 205 or Step 206;

Step 201: after obtaining the analytical results of the meteorological field data in GRIB format in the T639 global spectral model assimilated data, preparing for lattice formulation and performing Step 202;

Step 202: after preparing for lattice formulation as required in Step 201, interpolating the analytical results of the meteorological field data in GRIB format in the T639 global spectral model assimilated data into the corresponding model lattices horizontally and performing Step 203;

Step 203: after completing horizontal interpolation as required in Step 202, interpolating the analytical results of the meteorological field data in GRIB format in the T639 global spectral model assimilated data into the corresponding model lattices vertically and performing Step 204;

Step 204: obtaining the meteorological field information on the model lattices;

Step 205: after obtaining the analytical results of the meteorological field data in GRIB format in the T639 global spectral model assimilated data, carrying out model lattice formulation and performing Step 202 or Step 206;

Step 206: interpolating the analytical results of the meteorological field data in GRIB format in the T639 global spectral model assimilated data into the corresponding model lattices horizontally and performing Step 207;

Step 207: after completing horizontal interpolation as required in Step 206, interpolating the analytical results of the meteorological field data in GRIB format in the T639 global spectral model assimilated data into the corresponding model lattices vertically and performing Step 204.

The ultra-short-term forecasting method including real-time monitoring of the effect of upper and lower courses in the above embodiment uses the improved and optimized WRF mesoscale numerical forecasting model to carry out wind speed forecasting of the wind farms in Jiuquan Wind Power Base at all altitudes in 10 meters spacing within 10-120 meters based on the T639 global spectral model assimilated data; the forecast validity period is 60 hours, the forecast interval is 15 minutes and the horizontal resolution is 3 km. It uses the CALMET wind field diagnostic model for downscaling of the WRF mesoscale model to improve the forecasting ability and precision; uses the WRF-RUC system and the WRF3DVAR variational assimilation technique for running 4 cycles a day (start mode: the cycles starting from 12UTC and 0OUTC are cold start and the others are hot start) to achieve ultra-short-term forecasting through analysis and cycling. The forecasting method relates to the field of meteorological wind energy forecasting technologies and may be applied to wind power scheduling in the electric power industry.

For example, for the complex terrain and underlying surfaces in Hexi area of Gansu Province, numerical prediction and statistics may be used to develop wind speed forecasting methods and processes suitable for the area. Through studying the influence of the wind speed changes and propagation of the wind towers in the upper course on the wind towers in the lower course through analysis of the wind speed change characteristics of the wind towers, finally forecasting equations for the upper and lower courses were established to forecast the 10-20 min wind speed of the target wind towers, develop short-term forecasting correction technologies and carry out short-term and imminent forecasting of wind speed at all altitudes necessary for the wind farms.

Through statistics on the variation characteristics of the wind towers in Jiuquan, the characteristics of prevailing easterly and westerly winds with good consistency and regular wind speed propagation within Jiuquan Wind Power Base are used to study the influence of the wind speed changes and propagation of the wind towers in the upper course on the wind towers in the lower course through analysis of the wind speed change characteristics of 20 wind towers, finally the forecasting equations for the upper and lower courses were established to forecast the 10˜20 minutes wind speed of the target wind towers and develop short-term forecasting correction technologies; The effect of upper and lower courses and high and low altitude effect of wind speed was studied to establish forecasting equations on the wind speed of the wind power base in the future 0-3 hours. Statistical methods were used to analyze wind tower data of Jiuquan Wind Power Base and data of the meteorological observation stations and automatic stations by using statistical methods, study the spatial-temporal characteristics of the wind speed of the wind towers and the variation characteristics of wind speed with height, analyze the relationship between the wind speeds of the wind towers and surrounding observation stations and identify reference index stations in the upper course.

In addition, for example, the optimized WRF mesoscale numerical forecasting model may be used to carry out wind speed forecasting of the wind farms in Jiuquan Wind Power Base based on domestic T639 assimilated data combined with the climate characteristics in Jiuquan of Gansu Province. The forecast horizontal precision is 9 km, the forecast altitudes are 10 m, 70 m and 100 m, the forecast efficiency is 60 hours and the forecast interval is 15 minutes. The CALMET wind field diagnostic model was used to improve the horizontal precision of wind element forecasting; use the effect of upper and lower courses of wind towers to develop short-term forecasting correction technologies; establish wind power forecasting system for Jiuquan Wind Power Base and develop operational wind power forecasting products with high forecasting accuracy to provide technical support for wind power scheduling.

Specifically, statistical analysis was carried out on the observation data of 20 wind towers in Jiuquan Wind Power Base, reference index stations were chosen concerning the effect of upper and lower courses in different wind directions and screen for reference index stations with best correlation for each target wind tower, and statistical equations were established on the effect of upper and lower courses between the reference index stations and target wind towers through data analysis and statistics.

Computations were conducted by using the statistical equations on the effect of upper and lower courses between the corresponding reference index station and each target wind tower based on the wind direction and speed real-time monitoring data of the reference index stations in the upper course and forecast the future 5-10 minutes wind speed changes of the target wind towers. Correction combined with the model output forecast results formed forecasting of the ultra-short-term wind speed changes of the wind towers.

The ultra-short-term forecasting method including real-time monitoring of the effect of upper and lower courses in the above embodiments at least has the following characteristics:
(1) Improving and optimizing mesoscale numerical forecasting models, downscaling methods and wind tower meteorological data assimilation techniques to improve forecasting accuracy;
(2) Continuing to improve short-term and imminent forecasting technologies and adjusting the lattice spacing of wind tower layout for quality control of wind tower observation data;
(3) Studying the influence of the wind speed changes and propagation of wind towers in the upper course on wind towers in the lower course, developing forecasting method for upper and lower courses and use short-term and imminent forecasting technologies to provide a new idea for ultra-short-term wind power forecasting;
(4) Studying the spatial-temporal characteristics of the wind speed of wind towers and the variation characteristics of wind speed with height, analyzing the relationship between the wind speeds of wind towers and surrounding observation stations and identifying reference index stations in the upper course for wind speed forecasting;
(5) In short-term wind power forecasting, through effect comparison of 15 min 70 m height wind speed forecasting and wind tower data, the results show that the 24 hours forecasting relative error is 22.9-30%, the mean relative error is 26.97%, the absolute error is 1.6-2.3 m/s and the mean absolute error is 1.8 m/s, meeting the requirements of electric power dispatching.

Finally, it should be noted that: the foregoing is only preferred embodiments of the present invention and is not intended to limit the present invention. Although a detailed description of the present invention is carried out with reference to the foregoing embodiments, those skilled in the art may make modifications to the technical solution set forth in the foregoing embodiments or equivalent replacements to some technical features thereof. Within the spirit and principles of the present invention, any modification, equivalent replacement, improvement, etc., should be included in the present invention within the scope of protection.

1. An ultra-short-term forecasting method including real-time monitoring of the effect of upper and lower courses, comprising the following steps:
(a) obtaining ultra-short-term model forecast results through model lattices using the WRF-RUC (Weather Research and Forecasting-Rapid Update Cycle) system and the WRF3DVAR (Weather Research and Forecasting Three Dimensional Variational) variational assimilation technique based on T639 global spectral model course library data source, the CALMET (California Meteorological Model) wind field diagnostic model and static data;
wherein the step (a) specifically comprises the following substeps:
(a1) processing static data, downscaling the WRF mesoscale numerical forecasting model and generating model lattices based on the CALMET wind field diagnostic model;
(a2) reading the T639 global spectral model assimilated data, analyzing the meteorological field data in GRIB format in the T639 global spectral model assimilated data and interpolating into the corresponding model lattices based on the T639 global spectral model course library data source;
(a3) generating initial field and boundary conditions based on the meteorological field information on the model lattices; establishing main model program for cyclic integral forecast computation through analysis using the WRF-RUC system and the WRF3DVAR variational assimilation technique; and
(a4) starting the main model program for cycle operation to achieve ultra-short-term forecasting and obtain ultra-short-term model forecast results;
(b) carrying out numerical analysis and statistics and establishing statistical equations on the effect of upper and lower courses between the corresponding reference index station and each target wind tower for computing the effect of upper and lower courses of the target wind towers based on the wind tower database of the target wind power base and combined with the wind direction and speed real-time monitoring data of the reference index stations in the upper and lower courses;
(c) forecasting the future ultra-short-term wind speed changes of each target wind tower based on the computed results on the effect of upper and lower courses of each target wind tower and correcting combined with the ultra-short-term model forecast results to form forecasting of the ultra-short-term wind speed changes of the wind towers in the target wind power base; and
(d) obtaining forecasting of the future ultra-short-term wind speed changes of wind farms in the target wind power base at all altitudes in the target area after repeated cycling of the above operations.

2. The ultra-short-term forecasting method including real-time monitoring of the effect of upper and lower courses as claimed in claim 1 is characterized in that step (a) further comprises the following substep:
(a5) using plotting equipment to output model product, and outputting ultra-short-term model forecast results.

3. The ultra-short-term forecasting method including real-time monitoring of the effect of upper and lower courses as claimed in claim 1 is characterized in that, in step (a2), the operation to interpolate the analytical results of the meteorological field data in GRIB (General Regularly-distributed Information in Binary) format in the T639 global spectral model assimilated data into the corresponding model lattices specifically comprises the following substeps:
(a21) interpolating the analytical results of the meteorological field data in GRIB format in the T639 global spectral model assimilated data into the corresponding model lattices horizontally;
(a22) interpolating the analytical results of the meteorological field data in GRIB format in the T639 global spectral model assimilated data into the corresponding model lattices vertically.

4. The ultra-short-term forecasting method including real-time monitoring of the effect of upper and lower courses as claimed in claim 3 is characterized in that, before step (a21), it further comprises the following substep:
preparing for lattice formulation or carrying out model lattice formulation after obtaining the analytical results of the meteorological field data in GRIB format in the T639 global spectral model assimilated data.

5. The ultra-short-term forecasting method including real-time monitoring of the effect of upper and lower courses as claimed in claim 1 is characterized in that, in step (a4), the cycle operation is running 4 cycles a day; in the 4 cycles, the cycles starting from 12UTC and 0OUTC are cold start and the others are hot start.

6. The ultra-short-term forecasting method including real-time monitoring of the effect of upper and lower courses as claimed in claim 1 is characterized in that step (b) specifically comprises the following substeps:
(b1) obtaining the live monitoring data of the reference wind towers based on the wind tower database of the target wind power base;
(b2) for each target wind tower, screening for reference index station with best correlation concerning the effect of upper and lower courses in different wind directions through the optimal subset method;
(b3) establishing statistical equations on the effect of upper and lower courses between the corresponding reference index station and each target wind tower through numerical analysis and statistics based on the live monitoring data of the reference wind towers;
(b4) computing the effect of upper and lower courses of the target wind towers through the statistical equations on the effect of upper and lower courses between the corresponding reference index station and each target wind tower based on the wind direction and speed real-time monitoring data of the reference index stations in the upper and lower courses; and
(b5) forecasting the future ultra-short-term wind speed changes of each target wind tower based on the computed results on the effect of upper and lower courses of each target wind tower.

7. The ultra-short-term forecasting method including real-time monitoring of the effect of upper and lower courses as claimed in claim 6 is characterized in that, in substep (b4), the wind direction and speed real-time monitoring data of the reference index stations in the upper and lower courses includes the effect of upper and lower courses and high and low altitude effect of wind speed.

8. The ultra-short-term forecasting method including real-time monitoring of the effect of upper and lower courses as claimed in claim 6 is characterized in that, in step (b3), the statistical equations on the effect of upper and lower courses between the corresponding reference index station and each target wind tower include forecast equation on the wind speed of the wind power base in the future 0-3 hours;
in substep (b5), the set time of the future ultra short term includes 5-10 minutes.

9. The ultra-short-term forecasting method including real-time monitoring of the effect of upper and lower courses as claimed in claim 1 is characterized in that, in step (d), the target area includes areas in 10 meters spacing within 10-120 minutes and the altitudes include 10 meters altitude, 70 meters altitude and 100 meters altitude; in the forecasting of the future ultra-short-term wind speed changes of the wind farms in the target wind power base at all altitudes in the target area, the forecast efficiency is 60 hours and the forecast interval is 15 minutes.

10. The ultra-short-term forecasting method including real-time monitoring of the effect of upper and lower courses as claimed in claim 2 is characterized in that, in step (a2), the operation to interpolate the analytical results of the meteorological field data in GRIB (General Regularly-distributed Information in Binary) format in the T639 global spectral model assimilated data into the corresponding model lattices specifically comprises the following substeps:
(a21) interpolating the analytical results of the meteorological field data in GRIB format in the T639 global spectral model assimilated data into the corresponding model lattices horizontally;
(a22) interpolating the analytical results of the meteorological field data in GRIB format in the T639 global spectral model assimilated data into the corresponding model lattices vertically.

11. The ultra-short-term forecasting method including real-time monitoring of the effect of upper and lower courses as claimed in claim 2 is characterized in that, in step (a4), the cycle operation is running 4 cycles a day; in the 4 cycles, the cycles starting from 12UTC and 0OUTC are cold start and the others are hot start.
